(19) United States
(12) Patent Application Publication
(10) Pub. No.: US 2026/0010168 A1
(43) Pub. Date: Jan. 8, 2026

(54) PREEMPTIVE OBSTACLE DETECTION AND TRACKING UNDER NON-LINE-OF-SIGHT CONDITIONS

(71) Applicant: NEC Laboratories Europe GmbH, Heidelberg (DE)

(72) Inventors: Placido MURSIA, Heidelberg (DE); Lanfranco ZANZI, Heidelberg (DE); Francesco DEVOTI, Heidelberg (DE); Xi LI, Heidelberg (DE)

(21) Appl. No.: 19/064,780

(22) Filed: Feb. 27, 2025

(30) Foreign Application Priority Data
Jul. 4, 2024 (EP) 24186632

(51) Int. Cl. G05D 1/633; G05D 1/246; G05D 107/70; G05D 109/10; G05D 111/30; H04B 17/318; H04W 4/44

(52) U.S. Cl. CPC G05D 1/633; G05D 1/246; H04B 17/318; H04W 4/44; G05D 2107/70; G05D 2109/10; G05D 2111/32

(57) ABSTRACT

A computer-implemented method for preemptive obstacle detection and tracking in an environment includes the steps: a) constructing a power-angle measurement profile based on signal power indicators (SPIs) within a time interval, the SPIs including a measured power of each signal received via a reconfigurable intelligent surface (RIS) of a plurality of RISs located within the environment; b) mapping a reduction in the measured power in the power-angle measurement profile to a first RIS associated with a first angular sector of the environment to predict a presence of an obstacle therein; and c) updating a coordination plan associated with the RISs based on feedback to track the obstacle. Steps a)-c) are iteratively repeated to predict a presence of the obstacle in further angular sectors. A predicted trajectory of the obstacle is extrapolated over time based on the predicted presence of the obstacle in the angular sectors.

### CROSS REFERENCE TO RELATED APPLICATIONS

This application claims benefit to European Patent Application No. EP 24186632.6, filed on Jul. 4, 2024, which is hereby incorporated by reference herein.

### FIELD

The present disclosure relates to Artificial Intelligence (AI) and machine learning, and in particular to a method, system, data structure, computer program product and computer-readable medium for proactive detection and tracking of passive objects which are not in the direct field of view of a user equipment (UE).

### BACKGROUND

Conventional positioning techniques, such as the ones proposed in relevant standardization bodies (e.g., 3GPP, do not support localization and tracking of passive objects. While LIDAR, or other RADAR-like existing techniques allow performing accurate detection and ranging of the environment, they cannot overcome obstructions, as their operations are limited to the line-of-sight area.

### SUMMARY

In an embodiment, the present disclosure provides a computer-implemented method for preemptive obstacle detection and tracking in an environment. The method includes the steps: a) constructing a power-angle measurement profile based on a set of signal power indicators (SPIs) received from a user equipment (UE) within a time interval, wherein the set of SPIs include a measured power of each of a plurality of signals received at the UE within the time interval from a radio unit (RU) via at least one reconfigurable intelligent surface (RIS) of a plurality of RISs located within the environment; b) mapping a reduction in the measured power in the power-angle measurement profile to a first one of the RISs associated with a first angular sector of the environment to predict a presence of an obstacle in the first angular sector within the environment; and c) updating a coordination plan associated with the RISs based on feedback to track the obstacle. Steps a)-c) are iteratively repeated to predict a presence of the obstacle in further angular sectors of the environment. A predicted trajectory of the obstacle is extrapolated over time based on the predicted presence of the obstacle in the first angular sector and the further angular sectors.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates an example indoor scenario, according to an embodiment of the present disclosure;

FIG. 2 illustrates IDFCM functionalities, according to an embodiment of the present disclosure;

FIG. 3 illustrates a preemptive nomadic obstacle detection procedure, according to an embodiment of the present disclosure;

FIG. 4 illustrates a collected power measurements at the robot over time, according to an embodiment of the present disclosure;

FIG. 5 illustrates a self-conjugating reflective surface, according to an embodiment of the present disclosure; and

FIG. 6 is a block diagram of an exemplary processing system, which can be configured to perform any and all operations disclosed herein, according to an embodiment of the present disclosure.

### DETAILED DESCRIPTION

Embodiments of the present disclosure provide a method, system, computer-readable medium and computer program product that controls one or multiple available deployed RIS devices in a coordinated way to achieve proactive detection and tracking of passive objects (i.e., that are not connected to the network infrastructure), which are not in the direct field of view (non-line-of-sight) of a UE. Embodiments of the present disclosure describe passive sensing under non-line-of-sight (NLoS) conditions by extending the sensing area to portions of the space that are not in line of sight and providing a method to coordinate operation of devices in order to achieve passive sensing. The spatial and reflection properties of devices are coordinated to spatially guide the sensing operations to increase the sensing area and perform object tracking of objects within an environment. Embodiments of the present disclosure also differ from conventional approaches of tracking objects within an environment because embodiments of the present disclosure are able to perform sensing when measurements are taken by a moving device, e.g., the robot.

Integrated Sensing and Communication (ISAC) represents a holistic approach to system design that seamlessly integrates sensing capabilities with communication technologies. At its core, ISAC aims to enhance the efficiency, reliability, and intelligence of systems by enabling them to gather data from their surroundings and communicate that information effectively in real-time. In some embodiments, an ISAC system incorporates a variety of sensors, such as cameras, LiDAR, GPS, accelerometers, and environmental sensors, to collect data about their environment, objects, and events. These sensors provide valuable inputs for understanding the surroundings of the ISAC system, monitor performance, and detect anomalies or potential hazards. In addition to sensing capabilities, the ISAC system includes a communication and sensing infrastructure that leverages communication technologies to transmit and receive data, commands, and status updates. The communication and sensing infrastructure enables seamless interaction between the ISAC system and its operators, other systems, or the broader network. The communication and sensing infrastructure also allows for real-time monitoring, remote control, and collaborative decision-making, enhancing the autonomy and adaptability of the ISAC system.

Recent development in mobile radio communication and the inherent trend that brings the adoption of higher frequencies for communication e.g., 5G systems, has enabled further advancements in ISAC use-cases.

Reconfigurable intelligent surfaces (RISs) are devices that can be deployed to control a propagation environment in a programmable manner. In some embodiments, RISs include uniform planar arrays of antennas that relate to low-cost passive components allowing to control the way each antenna reflects the signal, typically by means of altering the phase of the signal being re-irradiated. Such ability can be used to control and enhance reflection properties of impeding signals, e.g., steer the reflection paths in the desired direction by means of the so-called passive beamforming techniques. The ability of changing the propagation channel conditions at will, and their very low cost compared to traditional (active) wireless devices, makes RISs particularly interesting for several applications ranging from communication enhancement to electromagnetic shielding. In some embodiments, RISs also find room in wireless sensing and localization applications, as well as joint communication and sensing applications, wherein they can enhance the coverage and rage of action of deployed devices and enhance their sensing capabilities (see e.g., Liu, R., Li, M., Luo, H., Liu, Q., & Swindlehurst, A. L. (2023). Integrated sensing and communication with reconfigurable intelligent surfaces: Opportunities, applications, and future directions. IEEE Wireless Communications, 30(1), 50-57, which is incorporated by reference herein).

Several approaches have been proposed to sense an environment, including passive objects present in the environment, with radio signals. One of the most common methods is radio detection and ranging (RADAR), that can detect the distance of targets in line of sight. A method to infer the presence and the position of humans from radio frequency (RF) signals utilizes a frequency modulated continuous waveform (FMCW) RADAR and process the received signal through a CNN architecture for high-dimensional convolution, extracting spatial-temporal information efficiently from RF signals. This approach can track human body key points. However, this method requires to perform complex signal processing steps and is thus not energy efficient as it requires specialized hardware and processing capabilities (see e.g., Zhao, M., Tian, Y., Zhao, H., Alsheikh, M. A., Li, T., Hristov, R., . . . & Torralba, A. (2018 August). RF-based 3D skeletons. In Proceedings of the 2018 Conference of the ACM Special Interest Group on Data Communication (pp. 267-281), which is incorporated by reference herein).

Another, similar approach called bi-static RADAR, operates in a similar way as a normal RADAR but with transmitter and receiver at different locations. Such approach is also adopted in ISAC applications, as transmitting and receiving devices are typically not co-located. Bi-static RADAR provides an approach that enables practical bistatic and asynchronous joint communication and sensing, achieving accurate target tracking. In particular, the signal is processed to extract micro-doppler and, based on that, perform the sensing (see e.g., Pegoraro, J., Lacruz, J. O., Azzino, T., Mezzavilla, M., Rossi, M., Widmer, J., & Rangan, S. (2024). JUMP: Joint communication and sensing with Unsynchronized transceivers Made Practical. IEEE Transactions on Wireless Communications, which is incorporated by reference herein).

Other approaches process only the received power to perform sensing while keeping the overall complexity of the localization/detection procedure low. For example, sensing and localization can be performed based on the power measurements that are regularly performed by IEEE802.11ad devices. In this approach, IEEE802.11ad access points are statically deployed in the monitored area. As per standard specification, such devices are continuously performing directional power measurements. Such power measurements are collected and processed to perform the sensing. In particular, changes in the measured power levels are leveraged to detect the presence of humans in the monitored area, further processing of power measurements with machine learning techniques is done to locate the detected human (see e.g., Devoti, F., Sciancalepore, V., Filippini, I., & Costa-Perez, X. (2020 July). PASID: Exploiting indoor mmWave deployments for passive intrusion detection. In IEEE INFOCOM 2020-IEEE Conference on Computer Communications (pp. 1479-1488). IEEE, which is incorporated by reference herein).

Embodiments of the present disclosure provide an approach is different from traditional RADAR-like and joint communication and sensing (JCAS) approaches as it leverages only power measurements, thus keeping the power consumption and computational complexity low. Embodiments of the present disclosure also differs from conventional approaches (described above) due to i) the ability of performing sensing when measurements are taken by a moving device, e.g., the robot, and ii) the ability of performing passive sensing under non-line-of-sight (NLoS) conditions. Indeed, it is important to note that existing approaches found in the state of the art, work only in line-of-sight conditions, hence embodiments of the present disclosure advance passive sensing techniques by extending the sensing area to portions of the space that are not in line of sight. Embodiments of the present disclosure have the ability of providing a method to coordinate devices operation in order to achieve passive sensing. This can leverage multistatic RADAR approach, where coordination relies on time and frequency synchronization of the distributed radars, to coherently combine the spatial diversity of transmitter-receiver views of the target. In accordance with some embodiments, the time and frequency synchronization includes a synchronization between a transmitter and a receiver for accurate target detection. Additionally, embodiments of the present disclosure are directed to using power measurements to enhance the target detection capabilities of conventional RADAR systems. In some additional embodiments, the present disclosure also describes a new level of coordination that involves directional transmission properties of the radio units (RUs) and the directional reflection properties of the RISs. Such level of coordination allows for directionally sensing changes in the environment. Hence coordination is leveraged to properly combine information from multiple distributed sources (see Serafino, G., Maresca, S., Scotti, F., Malacarne, A., Bogoni, A., Ghelfi, P., . . . & Lecomte, S. (2020). Sole project-demonstration of a multistatic and multiband coherent radar network. In Advanced Technologies for Security Applications: Proceedings of the NATO Science for Peace and Security ‘Cluster Workshop on Advanced Technologies’, 17-18 Sep. 2019, Leuven, Belgium (pp. 143-152). Springer Netherlands, which is incorporated by reference herein). Embodiments of the present disclosure also coordinate the spatial transmission and reflection properties of involved devices, to spatially guide the sensing operations so as to increase the sensing area and perform object tracking.

In a first aspect, the present disclosure provides a computer-implemented method for preemptive obstacle detection and tracking in an environment. The method includes the steps: a) constructing a power-angle measurement profile based on a set of signal power indicators (SPIs) received from a user equipment (UE) within a time interval, wherein the set of SPIs include a measured power of each of a plurality of signals received at the UE within the time interval from a radio unit (RU) via at least one reconfigurable intelligent surface (RIS) of a plurality of RISs located within the environment; b) mapping a reduction in the measured power in the power-angle measurement profile to a first one of the RISs associated with a first angular sector of the environment to predict a presence of an obstacle in the first angular sector within the environment; and c) updating a coordination plan associated with the RISs based on feedback to track the obstacle. Steps a)-c) are iteratively repeated to predict a presence of the obstacle in further angular sectors of the environment. A predicted trajectory of the obstacle is extrapolated over time based on the predicted presence of the obstacle in the first angular sector and the further angular sectors.

In a second aspect, the present disclosure provides the computer-implemented method according to the first aspect, wherein: a communication link is established between the RU and the UE before power-angle measurement profile is constructed; and a probe reference signal is sent from the radio unit to the UE via the plurality of RISs located within the environment.

In a third aspect, the present disclosure provides the computer-implemented method according to the first or second aspect, wherein constructing the power-angle measurement profile comprises providing instructions to the plurality of RISs to initiate a concurrent angular scan in the time interval, wherein each of the plurality of RISs is provided with a respective configuration.

In a fourth aspect, the present disclosure provides the computer-implemented method according to any of the first to third aspects, wherein the respective configuration of each of the RISs is updated based on determining that a second time interval after the time interval is initiated.

In a fifth aspect, the present disclosure provides the computer-implemented method according to any of the first to fourth aspects, wherein the respective configuration includes a specified width, granularity, and target direction for a respective one of the RISs.

In a sixth aspect, the present disclosure provides the computer-implemented method according to any of the first to fifth aspects, wherein updating the respective configuration of the respective RISs comprises modifying the specified width and target direction for the respective RISs, based on the predicted presence of the obstacle in the first angular sector within the environment.

In a seventh aspect, the present disclosure provides the computer-implemented method according to any of the first to sixth aspects, wherein a second angular sector of the further angular sectors is associated with a second one of the RISs located in the environment.

In an eighth aspect, the present disclosure provides the computer-implemented method according to any of the first to seventh aspects, wherein mapping the reduction in the power-angle measurement profile to the first one of the RISs is based on an environment map, locations of the plurality of RISs, and a location of the RU.

In a ninth aspect, the present disclosure provides the computer-implemented method according to any of the first to eighth aspects, wherein the obstacle is passively tracked in non-line-of-sight (NLOS) conditions.

In a tenth aspect, the present disclosure provides the computer-implemented method according to any of the first to ninth aspects, wherein constructing the power-angle measurement profile comprises providing instructions to the plurality of RISs to initiate a sequential angular scan in the time interval.

In an eleventh aspect, the present disclosure provides the computer-implemented method according to any of the first to tenth aspects, wherein predicting the presence of the obstacle in the first angular sector comprises determining a first direction in which the obstacle is headed, wherein the first direction is determined based on a first target direction for the first one of the RISs.

In a twelfth aspect, the present disclosure provides the computer-implemented method according to any of the first to eleventh aspects, wherein predicting the presence of the obstacle in the first angular sector further comprises: mapping the reduction in the measured power in the power-angle measurement profile to a second one of the RISs associated with a second angular sector of the further angular sectors of the environment; and determining a second direction in which the obstacle is located, wherein the second direction is determined based on a second target direction of the second one of the RISs.

In a thirteenth aspect, the present disclosure provides the computer-implemented method according to any of the first to twelfth aspects, wherein predicting the presence of the obstacle comprises determining a location of the obstacle within the environment based on an intersection of the first target direction and the second target direction.

In a fourteenth aspect, the present disclosure provides a computer system programmed for preemptive obstacle detection and tracking in an environment, the computer system comprising one or more hardware processors which, alone or in combination, are configured to provide for execution of the method according to any of the first to thirteenth aspects.

In a fifteenth aspect, the present disclosure provides a tangible, non-transitory computer-readable medium for preemptive obstacle detection and tracking in an environment, the computer-readable medium having instructions thereon, which, upon being executed by one or more processors, provides for execution of the method according to any of the first to thirteenth aspects.

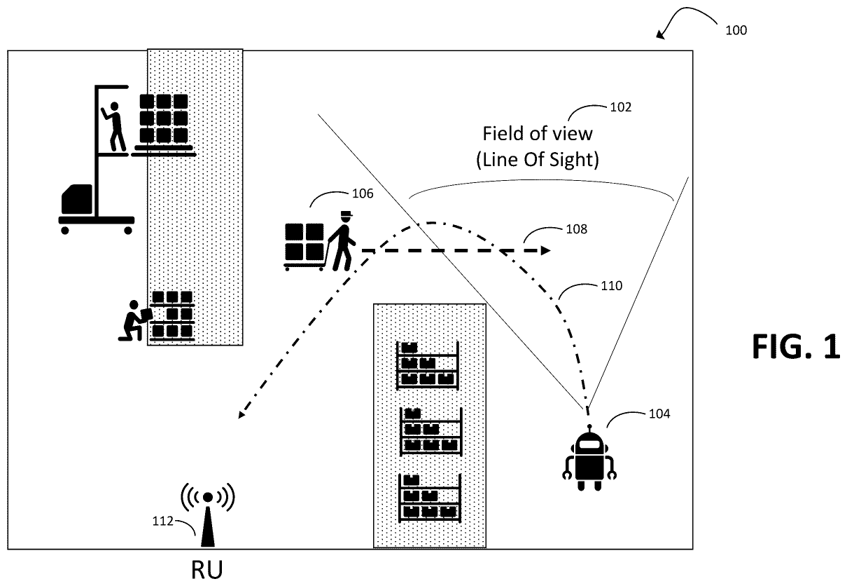

A running example is used herein to demonstrate the operation and improved functionality and performance of embodiments of the present disclosure. The running example, as shown in FIG. 1, includes an indoor setting (e.g., a factory or a warehouse) where a user equipment (UE) (e.g., robot) 104 is used to assist human workers (e.g., human worker 106) via conventional radio mapping (such as LiDAR) for the case of a single object to be detected and tracked. The robot 104 follows a pre-determined trajectory 110, which may be dynamically adjusted using the aforementioned radio mapping technology. On the other hand, the human worker 106 and/or other robots are performing several tasks concurrently within the same environment. In particular, embodiments of the present disclosure preemptively inform the robot 104 regarding the trajectory 108 of the humans/robots, which are in the “unseen” area, e.g., not in the line-of-sight of the robot 104 and are directly conflicting with the planned route 110 of the robot and hence can cause incidences or even injuries of the human worker 106 in the area. Embodiments of the present disclosure allow the robot to take better decisions in updating/modifying its current and future actions pre-emptively to avoid such situations and improves the safety of the working environment.

With conventional localization and mapping procedures, e.g., LiDAR technology, obstacles can be detected only when they are in the line-of-sight of the device. Embodiments of the present disclosure discover obstacles that are in blockage conditions whenever their presence and potential trajectory pose a significant constraint on the trajectory of the UE (e.g., robot 104).

Conventional techniques, such as the ones proposed in relevant standardization bodies, do not support localization and tracking of passive objects. While LiDAR, or other RADAR-like existing techniques allow performing accurate detection and ranging of the environment, they cannot overcome obstructions, as their operations are limited to the line-of-sight area. For this reason, embodiments of the present disclosure propose novel systems and methods to allow object detection and trajectory estimation by analyzing the received radio signals for sensing the location and movement of the objects, by exploiting RIS reconfiguration capabilities. Moreover, embodiments of the present disclosure capitalize on a coordination mechanism among multiple RISs to enhance the localization and tracking performance.

Since UEs, such as robots, are energy constrained devices, embodiments of the present disclosure allow keeping the overall hardware complexity and power expenditure at the robot low, as it enables offloading the sensing related signal processing at the network side and relies solely on power measurements.

Thus, embodiments of the present disclosure achieve localization and tracking of passive objects, which are in non-line-of sight conditions, while minimizing the overall complexity and power expenditure and by exploiting cooperation among multiple RIS nodes.

Embodiments of the present disclosure include a procedure to allow preemptive obstacle detection and tracking in blockage conditions, e.g., when the target obstacle is not in the line-of-sight of the device, using radio information.

In some embodiments, one radio unit (RU) 112 is deployed within the smart factory environment, as well as multiple RISs, which assist in the communication between the robot 104 and the environment of the factory. Moreover, the robot 104 is equipped with a receiving antenna. Lastly, a new logical node, labelled as Intelligent Data Fusion & Coordination Module (IDFCM) is defined, whose functionality is described in the following. In some embodiments, the IDFCM can be co-located with a physical node in the network, such as an RU 112, robot 104, or RISs.

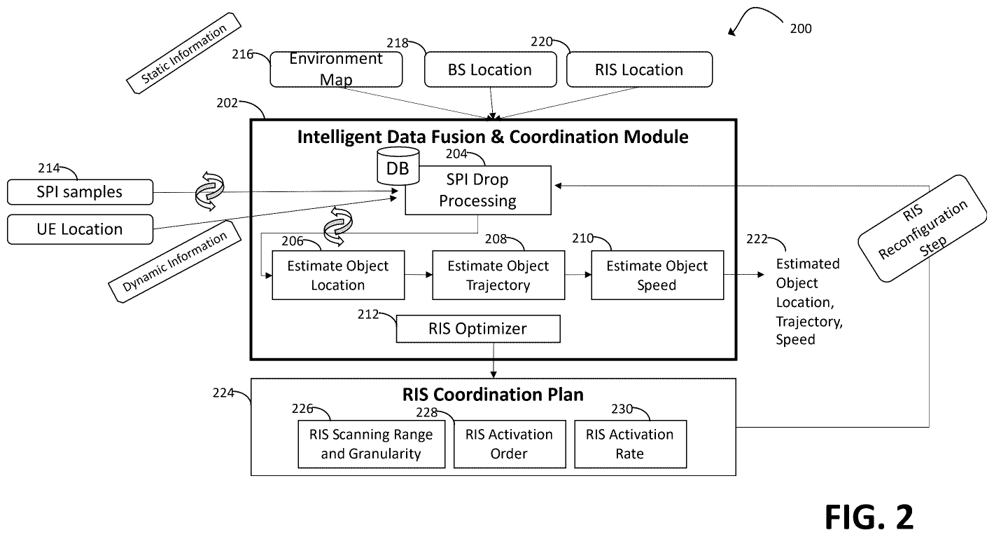

FIG. 2 illustrates IDFCM functionalities, according to an embodiment of the present disclosure.

The IDFCM 202, as shown in FIG. 2 are to: (i) handle data fusion based on the measured/collected sensing information from the UE; (ii) coordinate the scanning of multiple available RIS nodes or devices (in sequential or parallel), and (iii) finally extrapolate information on the position, trajectory and speed of detected objects, especially in non-line-of-sight conditions.

As depicted in FIG. 2, the IDFCM 202 consists of several function modules. As shown in FIG. 2, the IDFCM 202 includes an SPI Drop Processing module 204 that gathers and processes the available sensing data information (e.g., power measurement) collected by the UE (at the robot 104) over time to extrapolate passive object position and its estimated trajectory and speed in non-line-of-sight conditions.

The IDFCM 202 also includes a set of data fusion function modules, such as Estimate Object Location module 206, Estimate Object Trajectory module 208, and Estimate Object Speed module 210. The set of data fusion modules fuse the collected sensing information (e.g. the time interval when the power drops happen) together with an environment map 216, radio unit (RU) (e.g., base station (BS)) location 218, and RIS location 220 to extrapolate the object position, trajectory and speed, in non-line-of-sight conditions. In some embodiments, the environment map 216 includes all available static information related to the environment. The static information can include a location of walls, shelves, radio unit, and RISs provided by a network and/or environment owner during an initial deployment phase. In accordance with some additional embodiments, any dynamic information, such as a position of targets and/or humans in the environment is obtained by the IDFCM 202.

The IDFCM 202 comprises a RIS Optimizer 212 that is a coordination function module. The RIS Optimizer 212 iteratively refines in a coordinated way the configuration of the available RISs over time to allow tracking of nomadic objects. In accordance with some embodiments, the configuration of the available RISs includes RIS parameters associated with each individual RIS of the available RISs. The RIS parameters can include RIS unit cell states, and phase shifts, among other parameters, to obtain a specific beamforming direction. In accordance with some additional embodiments, initially, the RIS configuration (e.g., beamforming direction) for a respective individual RIS is set to span a large angular range, covering all the line of sight (LoS) area for the respective individual RIS. Once an initial target estimate position is available, the RIS beamforming direction is set to span a smaller angular range, centered around such estimated target position.

The IDFCM 202 comprises a set of communication function modules to connect with the robot and all RISs to allow its coordination and control as well as collection of relevant radio signal information from/to the robots and RISs. Such communication can be realized via wired connections (RIS control channel) or separate wireless control channels (robot and/or RISs).

The SPI Drop Processing module 204 continuously collects the Signal Power Indicator (SPI) information 214 from a UE (e.g., robot 104) based on its power measurement over time, and then processes the received SPI 214 to derive the location of the sensed power drops and forwards the analyzed sensing information to the set of data fusion modules 206, 208, and 210 to extrapolate the object position, trajectory and speed, in non-line-of-sight conditions, combining with the knowledge of the environment map 216, RU location 218, and RIS location 220. With all the estimated object location, trajectory and speed 222 as well as the given environment knowledge and available inputs, the RIS Optimizer 212 can derive an intelligent RIS coordination plan 224 including the suggestions for the RIS scanning range and granularity 226, the RIS activation order 228, and the RIS activation rate 230, etc. The derived RIS coordination plan 224 will be used to (re)configure the available RISs in the given planned coordinated manner. This procedure will be repeated during the operation phase based on the collected feedback of the robot 104, while the estimated object location, trajectory and speed 222 as output of the IDFCM 202 will also feedback to the robot 104 or the network to help better plan the navigation and/or task operation of the robot 104.

According to embodiments of the present disclosure, the UE (e.g., robot 104) receives a plurality of radio signals from the radio unit 112 that are reflected via RIS-1 302 or the RIS-2 304. The power of each signal is collected to form an SPI 214. The SPI 214 is provided to the IDFCM 202 using a feedback loop. The SPI 214 is used to derive the location of the sensed power drops and is forwarded to the set of data fusion modules 206, 208, and 210 to extrapolate the object position, trajectory and speed, in non-line-of-sight conditions, by combining with the knowledge of the environment map 216, RU location 218, and RIS location 220.

For example, the SPI 214 is directly associated to a specific RIS configuration (e.g., beamforming direction). Therefore, whenever a power drop is detected, it is concluded that an object causing signal blockage is present along the current beamforming direction of the RIS. Correlating this information for both RIS-1 302 and RIS-2 304 provides the IDFCM 202 with a specific point in space where the object can be present, rather than just a direction (e.g., by intersecting the estimated directions for the two RISs 302 and 304).

The RIS coordination plan comprises RIS configurations for both RIS-1 302 and RIS-2 304 (or in general for all the available RISs). Moreover, if an object estimated position and/or speed and direction is available, the available RISs are configured in such a way that they all focus their beamforming directions towards the estimated object position. For example, as described above, the initial RIS configuration (e.g., beamforming direction) for RIS-1 302 and RIS-2 304 can be set to span a large angular range, covering all the line of sight (LoS) area for the respective individual RISs. Once an initial target estimate position is available, the RIS beamforming direction is set to span a smaller angular range, centered around such estimated target position. The position of the object can be determined again after the configuration of RIS-1 302 and RIS-2 304 is updated. In some cases, updating the configurations of RIS-1 302 and RIS-2 304 includes setting the beamforming direction of the RIS-1 302 and the RIS-2 304 to span a smaller angular range.

The trajectory and speed of movement of the object can be inferred as long as two consecutive object positions are determined. The line connecting such two (or more) positions indicates the direction of movement, while the time difference at which the two positions have been estimated indicates the object speed. In accordance with some embodiments, the process described herein can be directly applied to more than 2 RISs, which can make the object position/direction/speed estimation more and more accurate.

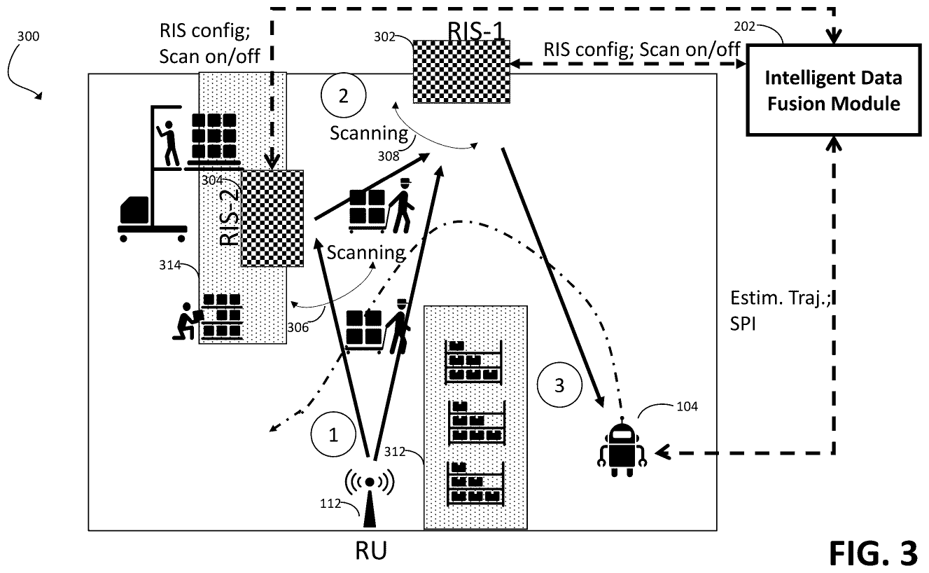

The reconfiguration procedure follows a series of steps, which are described as follows and labeled accordingly in FIG. 3.

FIG. 3 illustrates a preemptive nomadic obstacle detection procedure, according to an embodiment of the present disclosure.

The IDFCM 202 controls all the available RISs (RIS-1 302 and RIS-2 304) via separate control channels (e.g., in a smart factory environment, this could be represented by a physical cable), sequentially instructing them to perform an angular scanning of the environment in the shadowed areas 312 and 314 (with respect to a field of view of the robot 104) and re-directing the signal to the robot 104. In accordance with some embodiments, the shadowed areas 312 and 314 represent shelves in the environment 300 that provide signal blockage. For example, shelf 312 blocks the direct signal from the RU 112 to the robot 104. Any conventional radar-like technology at the robot 104, e.g., LiDAR, fails in detecting the objects/targets due to such blockage.

The robot 104 then collects power measurements over time and sends a Signal Power Indicator (SPI) 214 to the IDFCM 202. For example, the SPI 214 is a measurement of received signal power at the UE (e.g., robot 104), and reflects the channel conditions between the RU 112 and the UE (e.g., robot 104). This channel condition depends also on the reflections with one or more RISs 304 and 304.

The IDFCM 202 collects multiple SPI measurements 214 from the robot 104, and, whenever a significant power drop is detected, it correlates it with the available knowledge of the configurations of the RIS-1 302 and the RIS-2 304 during the corresponding time frame, as well as with the environment map 214, the locations of the RIS-1 302 and the RIS-2 304, and the location of the RU 218, to perform object detection, and to extrapolate the trajectory of the detected objects in time. Such estimated trajectories are then compared with the trajectory of the robot 104 and an associated update message is sent to the robot, if needed. In some embodiments, generic methods such as visual tools, specialized machine learning (ML) tools, or artificial intelligence (AI) engines can be used to compute object location and trajectory. In such embodiments, the computation of object location and trajectory can be based on the RIS node locations, the RU location, the collected RIS measurements, and the given environment information.

As a first step, the radio unit (RU) 112 sends probe signals to the i-th RIS-I (e.g., RIS-1 302, followed by RIS-2, 304), which are sequentially activated. The transmit signal propagates in the shadowed area, e.g., through the channel gᵢ(t)∈ [symbol] ^{N}^{ᵢ}^{×1}, where Nᵢ is the number of RIS-i elements. The series of transmit signals over time is represented by x(t)∈ [symbol] .

As a second step, the IDFCM 202 instructs the i-th RIS-i (e.g., RIS-1 302 and RIS-2, 304) to scan the environment by filtering a specific angular sector in the shadowed area and reflects back the signal to the robot 104 if a line-of-sight link to the robot 104 is available. Specifically, the IDFCM 202 sends a RIS coordination plan 224 to each RIS (RIS-1 302 followed by RIS-2 304), which includes, but is not limited to the activation/deactivation command for the scanning, the angular scanning range as well as its center angle, etc. Otherwise, the i-th RIS-i routes the signal to the next RIS, where the line-of-sight path to the robot 104 is available. For instance, as shown in FIG. 3, RIS-2 304 will route the signal to RIS-1 302, which in turn will reflect it to the robot.

In particular, the set of RIS-i phase shifts over time are represented with the diagonal matrix:

$${Φ}_{i} ( t ) ∈ {ℂ}^{{N}_{i} \times {N}_{i}} \qquad ( 1 )$$

where

$${Φ}_{i} ( t ) = diag ( {e}^{j {φ}_{i 1} ( t )} , … , {e}^{j {φ}_{{i}_{{N}_{i}}} ( t )} )$$

∀t and φᵢ(t)=(θᵢ(t), ϕᵢ(t)) represents the RIS-i configuration in terms of azimuth and elevation angles.

During this phase, the RIS-i changes its configuration at each time slot t in order to sequentially filter a 2D grid of receive directions in azimuth and elevation, e.g., filtering out the energy incoming from the chosen direction within the shadowed area, while reflecting the incoming signal to the robot.

In accordance with some embodiments of the present disclosure, the instantaneous location of the robot 104 in the environment is known at the IDFCM 202. This can be acquired by means of existing tools (see e.g., ROS Localization package, from wiki.ros.org; New Radio (NR) positioning support, from 3GPP, which are incorporated by reference herein). Alternatively, the position of a generic active UE can be estimated by standardized procedures.

If at a given time slot t the chosen filtering direction in the shadowed area is

$${φ}_{i}^{F} ( t ) ,$$

and the pointing direction to the robot is given by

$${φ}_{i}^{R} ( t ) ,$$

then the RIS-i configuration is recovered as

$${φ}_{i} ( t ) = {φ}_{i}^{R} ( t ) - {φ}_{i}^{F} ( t ) .$$

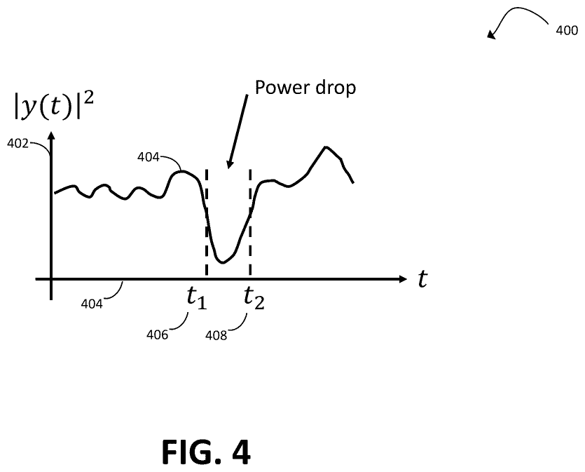

The robot 104 collects receive signal power measurements over time, as shown in FIG. 4.

FIG. 4 illustrates a graph of collected power measurements at the robot over time, according to an embodiment of the present disclosure. In some embodiments, received signal 404 over time is plotted in graph 400 of FIG. 4. In graph 400, a strength of the received signal is plotted on the y-axis 402 and time is plotted on the x-axis 404. The received signal is given as:

$$y ( t ) = {h}_{i}^{H} ( t ) {Φ}_{i} ( t ) {g}_{i} ( t ) x ( t ) + n ( t ) ∈ ℂ , \qquad ( 2 )$$

where

$${h}_{i}^{H} ( t ) ∈ {ℂ}^{1 \times {N}_{i}}$$

represents the channel vector from the RIS-i to the robot. Hence,

$${h}_{i}^{H} ( t )$$

can be represented by the LoS link to the robot, if available, or the path that reaches the latter via the next RIS. Lastly, and n(t)∈ [symbol] is the noise term. The robot 104 forwards the SPI 214 to the IDFCM 202 for further processing.

Since the RIS-i changes configuration at each time slot as specified in the coordination plan, the time interval in which the robot 104 has perceived a drop in received power, identified by the two indexes t₁ 406 and t₂ 408, can be directly mapped to a set of RIS-i configurations

$${\{ {φ}_{i} ( t ) \}}_{t = {t}_{1}}^{{t}_{2}} ,$$

and consequently to a set of filtering directions in the shadowed area

$${\{ {φ}_{i}^{F} ( t ) \}}_{t = {t}_{1}}^{{t}_{2}}$$

at the IDFCM 202, since the IDFCM 202 has the knowledge of the RISs configurations.

Such set of low power measurements along the shadowed area directions

$${\{ {φ}_{i}^{F} ( t ) \}}_{t = {t}_{1}}^{{t}_{2}}$$

are associated to a target causing signal blockage.

The procedure is iterated over time by continuously updating the coordination plan (and corresponding RIS configuration details) as to follow the sensed targets. In some embodiments, the targets are sensed using a methodology that is based on changes in power associated with a signal from an RU 112 that is received at the UE (e.g., robot 104). The changes in power received at the UE (e.g., robot 104) reveal the presence of unexpected object and/or obstacle in the environment 300. Specifically, the IDFCM 202 selects a new set of beamforming directions for each RIS-i (from the coordination plan) along the shadowed area, which is centered around the ones associated to the perceived drop in received power at the robot. This is done in a coordinated way among the available RISs, in order to maximize the localization and tracking accuracy. Indeed, whenever the IDFCM 202 has acquired at least two measurements of the filtering directions in the shadowed area associated to drops in performance, the proposed algorithm outputs an object trajectory, which is then updated with the subsequent measurements. Such trajectory can be refined with the use of Kalman filtering techniques, by which the current estimated object trajectory is a weighted sum of the current available measurement and the past observations. Note that, in the case where the two aforementioned measurements are highly similar, the object in question is deemed to be stationary, and thus this might not directly affect the trajectory of the robot 104.

The estimated object trajectory can be exploited to update the scanning range of each RIS so as to follow the estimated trajectory by taking into account the known location of each RIS. The angular width and granularity of such range depends on the estimated speed of the object, where a larger width allows to improve the tracking accuracy. Moreover, the order of the RIS scanning on/off as well as their activation rate depends on the estimated object trajectory and speed, respectively.

Alternatively, the hidden object detection and tracking can be performed directly by the robot 104. More specifically, the sensed power drops and corresponding time instants are directly processed at the robot 104, which however, has to know the sequence of the RISs scanning angles. Indeed, in this case, since the robot 104 may not have direct control of the RISs, the scanning is performed according to a pre-defined routine. In such embodiments, there is no need for a separate control channel between the IDFCM 202 and the robot 104. However, the latter would increase its power consumption due to the extra processing required and besides the robot may not be aware of all RIS devices and their positions in the environments.

The previous scenario assumes sequential RIS activation to avoid cross-interference in the detection allowing unique mapping of the detected signal drop with a specific RIS configuration and corresponding scanning angle. In some alternative embodiments, multiple RIS are concurrently active in the environment so as to enhance the object detection capabilities of the IDFCM 202.

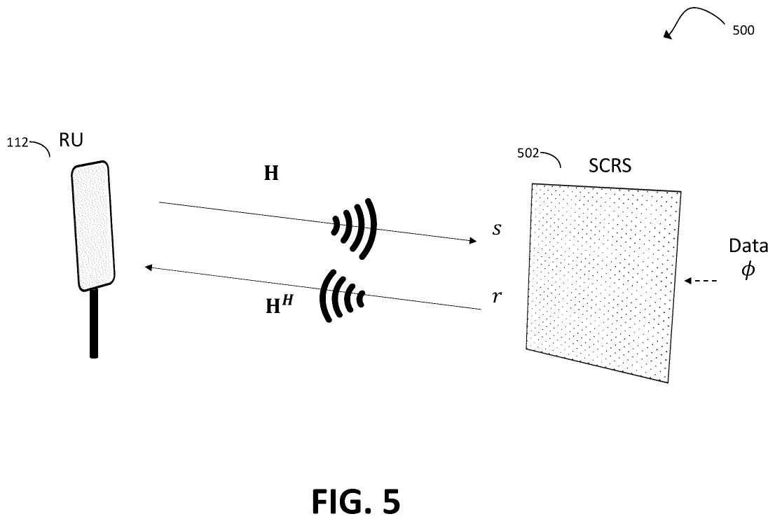

Embodiments of the present disclosure can be applied to RISs that are capable of embedding operational parameters into the radio reflected signal exploiting the features of Self-Conjugating Reflective Surfaces as depicted in FIG. 5.

FIG. 5 illustrates a self-conjugating reflective surface, according to an embodiment of the present disclosure. In some embodiments of the present disclosure, the square closed ring structure (SCRS) 502 is capable of detecting and decoding such information. The set of parameters included in the RIS reflected signal may encompass the following non-exhaustive list: RIS ID, its location, and beam configuration. In some embodiments, the reflection properties of SCRS 502 are fixed due to the complex conjugate operation at each element of the SCRS 502, which is equivalent to imposing a beam steering configuration on the reflected signal that is always pointing toward the direction of arrival of the impinging one, e.g., it is always reflecting back to the transmitting RU 112. The SCRS can also embed data in the reflected signal, that is considered to be detectable and decodable by the RU 112 (which is receiving the reflected signal with the embedded data).

By doing this, the sequential RIS activation can be overcome as radio information inputs to the IDFCM can be directly linked to the specific RIS deployed in the environment, and a signal power drop at the receiver can be directly mapped to the originating RIS.

By associating signal power drops with specific RIS units, the system can more accurately localize objects in the environment. This information can be used to track the movement of objects, determine their trajectories, and predict their future positions with greater precision. Moreover, with the ability to concurrently activate multiple RIS units and dynamically adjust their configurations based on environmental conditions and detected targets, the system gains flexibility and adaptability. It can respond quickly to changes in the environment or task requirements, optimizing performance in real-time.

Notably, the scanning phases and overall coordination plans of the multiple RISs in the environment are orchestrated by the IDFCM 202 by following specific requirements. For example, this simultaneous operation increases the coverage and effectiveness of the system, as each RIS can focus on different regions or aspects of the environment. Conversely, RISs could be synchronized and reconfigured to point in the same direction as to limit the occurrence of spurious situations and solve doubtful detections. Such trade-off is dynamically adjusted by the IDFCM 202 to meet specific QoS guarantees.

Additionally, while the above considered scenario assumes a single-antenna UE, alternate embodiments of the present disclosure can also consider the case of a multi-antenna UE. In this case, the receive combining vector needs to be updated based on the UE trajectory over time, in order to keep the beam alignment with the RISs. This decision can be optionally taken care of by the IDFCM, or by a separate control entity.

Embodiments of the present disclosure thus provide for general improvements to computers in machine learning systems for proactive detection and tracking of passive objects. Moreover, embodiments of the present disclosure can be practically applied to use cases to effect further improvements in a number of technical fields including, but not limited to, smart cities (e.g., automated traffic or vehicle control, smart districts, smart buildings, smart industrial plants, smart agriculture, energy management, etc.).

Embodiments of the present disclosure provide for the following improvements and technical advantages over existing technology:

A system and method allowing for passive detection and tracking of nomadic obstacles without direct line-of-sight with the UE, by exploiting the available deployed RIS devices, consisting of a system module, denoted as IDFCM, composed of the following functionalities:
a. A function that fuses together the available sensing information to extrapolate object position and trajectory, in non-line-of-sight conditions (as described in steps 6 and 9, below).
b. A function that coordinates the scanning of multiple RISs (in sequential or parallel) to extrapolate information on the position and trajectory of objects (The IDFCM to update the coordination plan of the available RIS scanning based on the real-time data feedback to track the detected object, as described in step 7 below).

In some embodiments, an advantage of the present is that a UE is allowed to preemptively detect and track objects even when they are in blockage conditions, e.g., not in its line-of-sight without the need of complex angle-of-arrival estimation techniques. Embodiments of the present disclosure overcome limitations of LIDAR (line-of-sight) with radio sensing abilities.

In an embodiment, the present disclosure provides a method and system for preemptively detecting and tracking the trajectory of nomadic obstacles comprising the following features:
1. The IDFCM to establish a communication link between the transmitter RU and the receiving UE via the RISs.
2. The IDFCM to instruct the RU to send a probe reference signal to the receiver UE, via the deployed RISs.
3. The IDFCM instructing one or multiple RISs to start a concurrent (e.g., parallel) angular scan, with specified width, granularity, and target direction according to the current coordination plan.
4. The available RISs scanning the environment by changing its configuration at each time slot in order to sequentially filter a 3D grid of incoming signal directions and reflecting to the receiver UE. As described above, the RIS configuration is changed such that the beamforming direction spans a given angular range. This angular range, as described above, is updated over time to follow the target. Initially, when there is no estimated target position available yet, it is set to a wide range. The configuration change refers to changing the RIS unit cell states (e.g., phase shifts). In accordance with some additional embodiments, the RIS unit cell states are set to beamform in a specific direction in azimuth and elevation. In such settings, the RIS effectively filters incoming signals to include the signal components that come from the specific direction. Therefore, in case a target lies along the specific direction, it will create a signal power drop due to blockage.
5. The receiver UE collecting power measurements over time (SPIs) and

forwarding them to the IDFCM. In some embodiments, the collected power measurements can be either grouped at the UE and transmitted in block to the IDFCM or forwarded from the UE to the IDFCM as they are recorded.
6. The IDFCM to construct a power-angle measurement profile by processing the SPI values over time, and mapping any significant drop in the received power with the corresponding RIS configurations during that time interval, as well as the information regarding the environment map, BS location and RIS location, which are available at the IDFCM, and consequently to a specific angular sector in the environment. In some embodiments, the power-angle measurement profile provides a spatial mapping between received power and reflection angle. For example, the power-angle measurement profile links received power at time ‘t’ with a corresponding steering angle of the RISs which is activated at time ‘t.’ The power-angle measurement profile is constructed using the mapping of power drops with RIS configurations (e.g., beamforming directions or angles). For example, 1) at time t_1 a power drop of value P_1 was perceived; 2) The RIS at time t_1 was configured to beamform at T_1 degrees; 3) a point is placed on the graph with coordinates (T_1, P_1). An angular sector is simply a confined (not infinite) set of angles in space (e.g., from 30 to 60 degrees). The environment is divided into sectors depending on the RIS location and the map of the environment. For example, as shown with respect to RIS-1 302 in FIG. 3, assuming that 0 deg corresponds to the normal to the surface, the interesting angular sectors would be [−90, 90]. As stated above, this angular sector is refined (reduced) once an initial target estimated position is acquired.
7. The IDFCM to update the coordination plan of the available RIS scanning based on the real-time data feedback to track the detected object. In some embodiments, the real-time data feedback refers to SPI measurements determined previously. In accordance with some additional embodiments, by updating the coordination plan of the available RIS scanning based on real-time data feedback, the case of multiple RISs scanning the same angular sector is avoided, when sequential RIS scanning is implemented. Additionally, updating the coordination plan is helpful in the case of concurrent RIS scanning, as the coordination plan instructs the RISs on which angular sectors to sweep, and in which order.
8. The IDFCM to iteratively repeat previously described features 2-7. In some embodiments, the iterations can be performed at different time intervals. For example, the frequency of iterations is based on the capacity of available hardware and the mobility environment. In case of low-mobility environments, the frequency of iterations can be low, whereas in the case of high-mobility scenarios, the frequency of iterations can be as fast as the hardware (e.g., RIS, IDFCM, and RU) allows.
9. The IDFCM to extrapolate an estimated object trajectory over time based on the collected angular sector estimations. In some embodiments, the number of angular sector estimations that are performed, are based on available hardware capabilities and the level of mobility of targets. In accordance with some embodiments, if an estimation of how fast a target moves in the environment is available, a trade-off is made between accurate object tracking (e.g., fast measurements) and low power consumption (e.g., slow measurements).

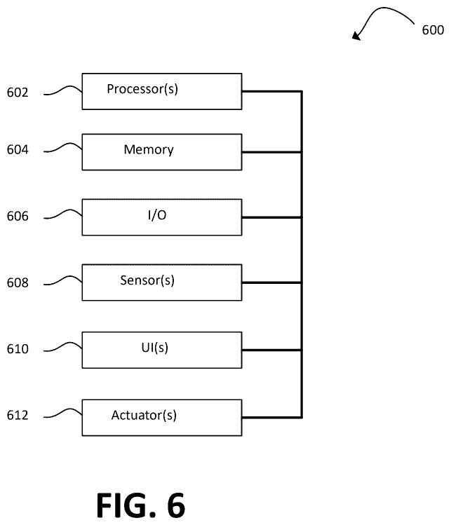

Referring to FIG. 6, a processing system 600 can include one or more processors 602, memory 604, one or more input/output devices 606, one or more sensors 608, one or more user interfaces 610, and one or more actuators 612. Processing system 600 can be representative of each computing system disclosed herein.

Processors 602 can include one or more distinct processors, each having one or more cores. Each of the distinct processors can have the same or different structure. Processors 602 can include one or more central processing units (CPUs), one or more graphics processing units (GPUs), circuitry (e.g., application specific integrated circuits (ASICs)), digital signal processors (DSPs), and the like. Processors 602 can be mounted to a common substrate or to multiple different substrates.

Processors 602 are configured to perform a certain function, method, or operation (e.g., are configured to provide for performance of a function, method, or operation) at least when one of the one or more of the distinct processors is capable of performing operations embodying the function, method, or operation. Processors 602 can perform operations embodying the function, method, or operation by, for example, executing code (e.g., interpreting scripts) stored on memory 604 and/or trafficking data through one or more ASICs. Processors 602, and thus processing system 600, can be configured to perform, automatically, any and all functions, methods, and operations disclosed herein. Therefore, processing system 600 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 600 can be configured to perform task “X”. Processing system 600 is configured to perform a function, method, or operation at least when processors 602 are configured to do the same.

Memory 604 can include volatile memory, non-volatile memory, and any other medium capable of storing data. Each of the volatile memory, non-volatile memory, and any other type of memory can include multiple different memory devices, located at multiple distinct locations and each having a different structure. Memory 604 can include remotely hosted (e.g., cloud) storage.

Examples of memory 604 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 604.

Input-output devices 606 can include any component for trafficking data such as ports, antennas (i.e., transceivers), printed conductive paths, and the like. Input-output devices 606 can enable wired communication via USB®, DisplayPort®, HDMI®, Ethernet, and the like. Input-output devices 606 can enable electronic, optical, magnetic, and holographic, communication with suitable memory 606. Input-output devices 606 can enable wireless communication via Wi-Fi®, Bluetooth®, cellular (e.g., LTE®, CDMA®, GSM®, WiMAX®, NFC®), GPS, and the like. Input-output devices 606 can include wired and/or wireless communication pathways.

Sensors 608 can capture physical measurements of environment and report the same to processors 602. User interface 610 can include displays, physical buttons, speakers, microphones, keyboards, and the like. Actuators 612 can enable processors 602 to control mechanical forces.

Processing system 600 can be distributed. For example, some components of processing system 600 can reside in a remote hosted network service (e.g., a cloud computing environment) while other components of processing system 600 can reside in a local computing system. Processing system 600 can have a modular design where certain modules include a plurality of the features/functions shown in FIG. 3. For example, I/O modules can include volatile memory and one or more processors. As another example, individual processor modules can include read-only-memory and/or local caches.

While embodiments of the disclosure have been illustrated and described in detail in the drawings and foregoing description, such illustration and description are to be considered illustrative or exemplary and not restrictive. It will be understood that changes and modifications may be made by those of ordinary skill within the scope of embodiments of the present disclosure. In particular, the present disclosure covers further embodiments with any combination of features from different embodiments described above and below. Additionally, statements made herein characterizing the invention or disclosure refer to an embodiment of the invention or disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for preemptive obstacle detection and tracking in an environment, the method comprising:
a) constructing a power-angle measurement profile based on a set of signal power indicators (SPIs) received from a user equipment (UE) within a time interval, wherein the set of SPIs include a measured power of each of a plurality of signals received at the UE within the time interval from a radio unit (RU) via at least one reconfigurable intelligent surface (RIS) of a plurality of RISs located within the environment;
b) mapping a reduction in the measured power in the power-angle measurement profile to a first one of the RISs associated with a first angular sector of the environment to predict a presence of an obstacle in the first angular sector within the environment;
c) updating a coordination plan associated with the RISs based on feedback to track the obstacle;
d) iteratively repeating steps a)-c) to predict a presence of the obstacle in further angular sectors of the environment; and
e) extrapolating a predicted trajectory of the obstacle over time based on the predicted presence of the obstacle in the first angular sector and the further angular sectors.

2. The computer-implemented method according to claim 1, wherein:
a communication link is established between the RU and the UE before power-angle measurement profile is constructed; and
a probe reference signal is sent from the radio unit to the UE via the plurality of RISs located within the environment.

3. The computer-implemented method according to claim 1, wherein constructing the power-angle measurement profile comprises:
providing instructions to the plurality of RISs to initiate a concurrent angular scan in the time interval, wherein each of the plurality of RISs is provided with a respective configuration.

4. The computer-implemented method according to claim 3, wherein the respective configuration of each of the RISs is updated based on determining that a second time interval after the time interval is initiated.

5. The computer-implemented method according to claim 4, wherein the respective configuration includes a specified width, granularity, and target direction for a respective one of the RISs.

6. The computer-implemented method according to claim 5, wherein updating the respective configuration of the respective RISs comprises:
modifying the specified width and target direction for the respective RISs based on the predicted presence of the obstacle in the first angular sector within the environment.

7. The computer-implemented method according to claim 1, wherein a second angular sector of the further angular sectors is associated with a second one of the RISs located in the environment.

8. The computer-implemented method according to claim 1, wherein mapping the reduction in the power-angle measurement profile to the first one of the RISs is based on an environment map, locations of the plurality of RISs, and a location of the RU.

9. The computer-implemented method according to claim 1, wherein the obstacle is passively tracked in non-line-of-sight (NLOS) conditions.

10. The computer-implemented method according to claim 1, wherein constructing the power-angle measurement profile comprises providing instructions to the plurality of RISs to initiate a sequential angular scan in the time interval.

11. The computer-implemented method according to claim 1, wherein predicting the presence of the obstacle in the first angular sector comprises determining a first direction in which the obstacle is headed, wherein the first direction is determined based on a first target direction for the first one of the RISs.

12. The computer-implemented method according to claim 11, wherein predicting the presence of the obstacle in the first angular sector further comprises:
mapping the reduction in the measured power in the power-angle measurement profile to a second one of the RISs associated with a second angular sector of the further angular sectors of the environment; and
determining a second direction in which the obstacle is located, wherein the second direction is determined based on a second target direction of the second one of the RISs.

13. The computer-implemented method according to claim 12, wherein predicting the presence of the obstacle comprises determining a location of the obstacle within the environment based on an intersection of the first target direction and the second target direction.

14. A computer system programmed for preemptive obstacle detection and tracking in an environment, the computer system comprising one or more hardware processors which, alone or in combination, are configured to provide for execution of the following steps:
a) constructing a power-angle measurement profile based on a first set of signal power indicators (SPI) received from a user equipment (UE) within a time interval, wherein the set of SPIs include a measured power of each of a plurality of signals received at the UE within the time interval from a radio unit (RU) via at least one reconfigurable intelligent surface (RIS) of a plurality of RISs located within the environment;
b) mapping a reduction in the measured power in the power-angle measurement profile to a first one of the RISs associated with a first angular sector of the environment to predict a presence of an obstacle in the first angular sector within the environment;
c) updating a coordination plan associated with the RISs based on the feedback to track the obstacle;
d) iteratively repeating steps a)-c) to predict a presence of the obstacle in further angular sectors of the environment; and
e) extrapolating a predicted trajectory of the obstacle over time based on the predicted presence of the obstacle in the first angular sector and the further angular sectors.

15. A tangible, non-transitory computer-readable medium for preemptive obstacle detection and tracking in an environment, the computer-readable medium having instructions thereon, which, upon being executed by one or more processors, provides for execution of the following steps:
a) constructing a power-angle measurement profile based on a first set of signal power indicators (SPI) received from a user equipment (UE) within a time interval, wherein the set of SPIs include a measured power of each of a plurality of signals received at the UE within the time interval from a radio unit (RU) via at least one reconfigurable intelligent surface (RIS) of a plurality of RISs located within the environment;
b) mapping a reduction in the measured power in the power-angle measurement profile to a first one of the RISs associated with a first angular sector of the environment to predict a presence of an obstacle in the first angular sector within the environment;
c) updating a coordination plan associated with the RISs based on feedback to track the obstacle;
d) iteratively repeating steps a)-c) to predict a presence of the obstacle in further angular sectors of the environment; and
e) extrapolating a predicted trajectory of the obstacle over time based on the predicted presence of the obstacle in the first angular sector and the further angular sectors.
